(19) United States
(12) Patent Application Publication
(10) Pub. No.: US 2008/0040390 A1
(43) Pub. Date: Feb. 14, 2008

(54) VENDOR MSDS MANAGEMENT AND REGULATORY COMPLIANCE SYSTEMS AND METHODS

(75) Inventors: Leonid Solomon Oves, Potomac, MD (US); James John Ralph, Oceanside, NJ (US); Tamie Lynn Webber, Portland, OR (US)

Correspondence Address: PILLSBURY WINTHROP SHAW PITTMAN LLP, ATTENTION: DOCKETING DEPARTMENT, P.O BOX 10500, McLean, VA, 22102, US

(73) Assignee: 3E COMPANY ENVIORNMENTAL, ECOLOGICAL AND ENGINEERING, Carlsbad, CA (US)

(21) Appl. No.: 11/695,558

(22) Filed: Apr. 2, 2007

Related U.S. Application Data
(60) Provisional application No. 60/787,966, filed on Mar. 31, 2006.

(51) Int. Cl. G06F 17/00

(52) U.S. Cl. 707/104.1; 707/E17.003

(57) ABSTRACT

Systems and methods are described that provide regulatory data associated with chemical products. Methods and systems are provided for identifying constituents of the chemical products and for obtaining regulatory data and other information associated with the chemical products. Regulatory data and other chemical data can be obtained from various sources, including government agencies and other regulatory authorities in plural jurisdictions, states and countries. Included in the regulatory data is information that governs handling, shipping, selling, storing, use and disposal of the chemical products. Systems and methods are described that provide improved and automate access to relevant regulatory data.

### CROSS-REFERENCE TO RELATED APPLICATIONS

The present application claims priority from U.S. Provisional Patent Application Ser. No. 60/787,966 entitled “Vendor MSDS Management and Regulatory Compliance Systems and Methods,” filed Mar. 31, 2006. The present Application is also related to U.S. patent application Ser. No. 11/691,356 entitled “Environmental, Health and Safety Data Manager with Application Loaders,” which was filed Mar. 26, 2007 and which application is incorporated herein by reference and for all purposes.

### BACKGROUND OF THE INVENTION

### Description of Related Art

Global companies face the daunting challenge of efficiently monitoring continuously increasing and evolving complex requirements promulgated by regulatory agencies around the world. Managing information associated with environmental, health and safety compliance is a complex, time consuming, resource intensive and often expensive task. Manufacturers and distributors are especially challenged because they have complex internal and external obligations. Internally, they must ensure the safety of their own employees. Externally, they must ensure the safety of their products, provide information to their downstream customers, and comply with government regulations related to import/export, hazard communication, new chemical notification, reporting and the restriction on marketing and use of hazardous substances. Compliance poses challenges associated with maintenance of ever changing and growing inventory of Material Safety Data Sheets (“MSDSs”) for multiple sites and management of hazardous material (“HazMat”) spills and waste, and regulatory reporting. Compliance is typically an unavoidable obligation, mandated by government agencies and insurance companies. Furthermore, beyond regulatory requirements, access to up-to-date compliance related information can improve working environment for employees.

### BRIEF SUMMARY OF THE INVENTION

Certain embodiments of the present invention provide environment, health, and safety (“EH&S”) data integration, data management, and decision support systems and methods. In certain embodiments, systems and methods are provided for the integration of an MSDS management system (“MMS”) such as the MMS® system provided by 3E Company of Carlsbad Calif. and a chemical regulatory compliance database (“RCD”) such as the Ariel WebInsight® provided by 3E Company of Carlsbad Calif. Such integration can enable EH&S professionals to access relevant chemical regulatory information directly from chemical inventory MSDSs, providing a unique, unparalleled blend of resources for managing EH&S compliance needs at both the product and chemical constituent levels.

Certain embodiments provide the MMS direct access to comprehensive global regulatory content maintained by the RCD that may include information derived from more than 650 regulatory lists, 320,000 substances and 60+ countries throughout the world. Integration of the MMS with an RCD can provide advanced capabilities to users for managing vendor MSDSs and associated chemical data, the capabilities including complete visibility and control over the impact of specific chemical regulations on products and raw material inventories.

In many embodiments, an innovative regulatory impact analysis feature can enable users to view regulatory changes that specifically apply to products of interest such as products maintained in users' inventories. Information obtained by implementing regulatory impact analysis features can then be used to modify safety programs, policies and training and improve workplace safety. Additionally, users can be notified of changes in regulations that may effect reporting requirements. Prompt, appropriate response to regulatory changes can positively impact regulatory compliance and increase workplace safety.

Thus, aspects of the invention facilitate management of complex regulatory compliance while reducing costs.

### BRIEF DESCRIPTION OF THE DRAWINGS

The present invention is illustrated by way of example, and not limitation, in the figures of the accompanying drawings in which like references denote similar elements, and in which:

FIG. 1 is a schematic describing one embodiment according to certain aspects of the invention;

FIGS. 2-11 are exemplars of user input and output in one embodiment of the invention; and

FIG. 12 illustrates an example of dataflow in one embodiment of the invention.

### DETAILED DESCRIPTION OF THE INVENTION

The present invention will now be described in detail with reference to the drawings, which are provided as illustrative examples of the invention so as to enable those skilled in the art to practice the invention. Notably, the figures and examples below are not meant to limit the scope of the present invention. Where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the known components referred to herein by way of illustration.

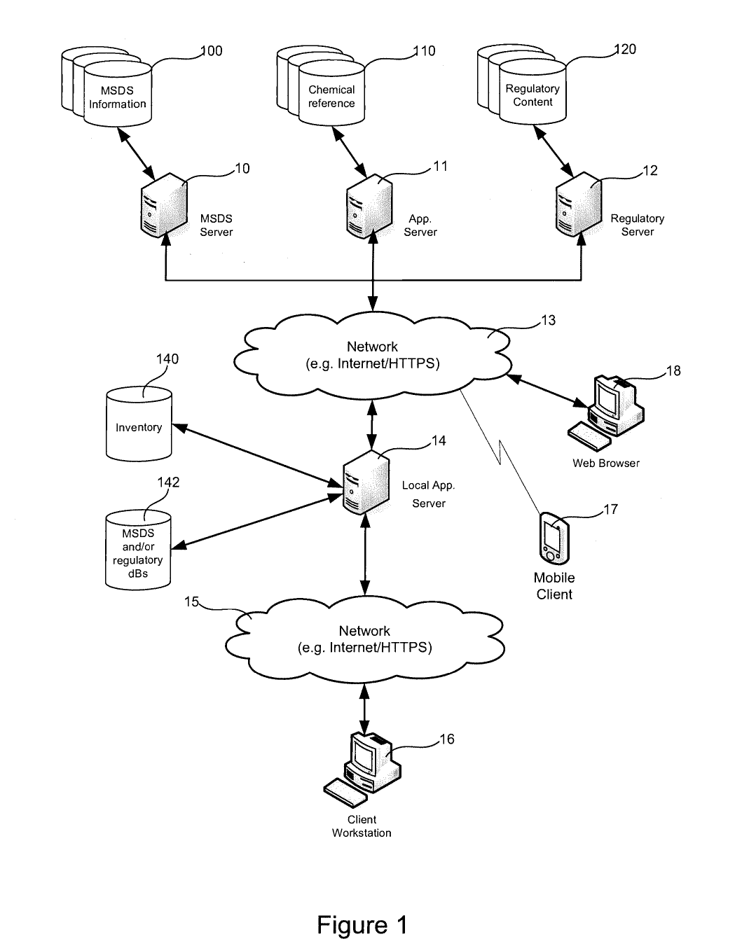

FIG. 1 is a generalized depiction of one example of a system according to certain aspects of the invention. In the example, an MSDS server 10 maintains MSDS information 100, including compilations of MSDS documents, summaries of MSDS documents, digests of MSDS documents, cross-referencing information, MSDS meta data and other such information. MSDS information 100 may be maintained in one or more databases and/or in some suitably arranged structured or unstructured storage. MSDS information, documents and meta data may include information related to composition and characteristics of chemical products and materials and can also include safety information related to the use, storage, manufacture, transportation, disposal and disposal of chemical products. MSDS information, documents and meta data may include information regarding constituent and derivative components and chemicals of the chemical products as well as information describing interactions and interactivities.

An RCD may be provided that comprises a regulatory server 12 for maintaining regulatory content 120 related to chemicals and chemical products. Regulatory information 120 can be compiled and maintained in storage, structured or unstructured and/or in a database. Typically, MSDS server 10 and regulatory server 12 are configurable to update MSDS information 100 and regulatory content 120, respectively. MSDS server 10 and regulatory server 12 may cooperate to provide information related to chemicals or chemical products responsive to user queries.

In certain embodiments, an application server 11 may be provided to receive queries from users, wherein the queries can take the form of one or more MSDSs, a list of chemical products and/or an inventory listing a plurality of chemicals and chemical products. Application server 11 may derive lists of constituents and related chemicals from MSDS information 100 and from an MSDS provided in a query, wherein the constituents and related chemicals include chemicals and compounds present in the chemical products, derivatives of chemicals in the chemical products and other chemical products associated with or extracted from the MSDS information 100. Additionally or alternatively, application server 11 may compile lists of chemicals and chemical products based on information provided in the inventory. The information in the inventory may comprise identification of chemicals and chemical products stored, used, sold, fabricated and transported by the user together with information that may include origin, destination, quantity, concentration, date of manufacture, batch numbers and other information related to chemicals and chemical products of interest.

The application server 11 may generate queries to obtain MSDS information 100 from the MSDS server 10 and regulatory content 120 from the regulatory server 12. The application server 11 may make use of chemical reference information 110 that can be obtained from any of a plurality of sources including, government, regulatory authorities, manufacturers, suppliers, industry groups and research establishments. The application server 11 may also maintain a local database of certain chemical reference information.

In certain embodiments, MSDS server 10, regulatory server 12 and application server 11 are provided as one or more central servers. Each of central servers 10-12 may be implemented on individual servers that communicate using one or more networks including the Internet 13. Communication may be secured using suitable encryption or other secure communications technology. Each of servers central 10-12 can also be implemented as a distributed system communicating by a network. In certain embodiments, the functions of two or more of central servers 10-12 can be performed by a single server and, in some embodiments, portions of functionality of the central servers 10-12 can be performed on a single server or a single set of distributed servers.

In certain embodiments, a local server 14 interacts with client workstations 16 and generates requests to the central servers 10-12. The local server may be restricted to communication with an application server 11, but may be permitted to communicate directly with MSDS server 10 or regulatory server 12 as necessary or desired and levels of access can be based on subscription levels. Local server 14 may maintain one or more databases 140 and 142 or other forms of storage such as DVD, CD-ROM, disk array, etc. Typically, local server 14 maintains one or more inventory databases 140 that can track chemicals and chemical products associated with the user. Inventory databases 140 can be populated with information tracked in business operations systems, including purchasing, production and sales database systems. In that regard, an inventory database function may also be provided by a specialized inventory system or as a component of the business operations systems. The local server 14 may also maintain one or more databases 142 for tracking MSDS and regulatory information including data received from central servers 10-12.

In certain embodiments, certain functionalities of local server 14 may be included in one or more of the central servers 10-12. Such centralization of local server 14 may provide economies of scale and improve responsiveness. For example, the functions of the local server 14 may be provided more economically for a plurality of smaller subscribers if the functions are centralized. Improved responsiveness may be obtained from centralized local server 14 functions when, for example, a high volume of queries requiring access to databases 100, 110 and 120. Centralizing local server 14 functions may also provide improved service to standalone computing devices 18 and wireless or other mobile devices 17.

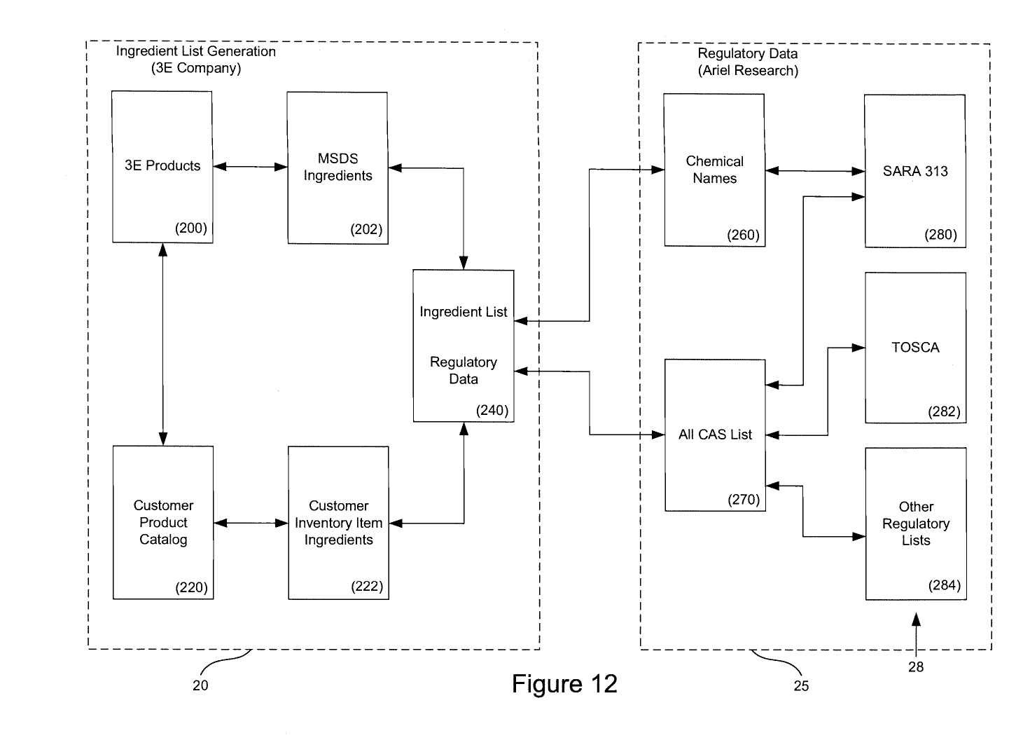

FIG. 12 is a simplified block schematic of dataflow in one embodiment of the invention. In this example, chemical information is managed in a first system 20 while regulatory data related to chemicals is managed in a second system 25. In the example shown, the first system 20 generates, maintains, updates and processes MSDS data, inventory and ingredients using tools and systems offered by 3E Company of Carlsbad Calif. and the second system gathers, maintains, updates and processes regulatory data using Ariel Research tools and systems provided by 3E Company of Carlsbad Calif.

In certain embodiments systems and methods provide an MMS that permits the use of MSDS information 100 to directly access comprehensive global regulatory content 28 provided by an RCD whereby the global content can span in excess of 650 regulatory lists, 320,000 substances and more than 60 countries throughout the world. Integration of an MMS with chemical regulatory databases can provide advanced capabilities to users for managing vendor Material Safety Data Sheets (MSDS) and associated chemical data, the capabilities including complete visibility and control over the impact of specific chemical regulations on products and raw material inventories. Subscribers to certain of the described systems can rapidly obtain complete, up-to-date regulatory data concerning chemical products in their inventories, typically through simple web-based interfaces.

In certain embodiments, inbound MSDSs can be analyzed and validated from a chemical and regulatory standpoint to further define composition of chemical products. Additional proprietary ingredient information 222, analysis of the listed composition 202, including data provided by the MSDSs, and/or additional classification data may be required to refine the information provided by vendors of the chemical products and to improve regulatory reporting accuracy. Upon receipt from a manufacturer, such information may be entered and stored by and/or within the MMS. In one example, an “ingredients override” process may be implemented to receive and process data received from manufacturers and vendors. Direct access to global regulatory content 28 can be based on refined MSDS data after data is entered and processed.

In certain embodiments, inventory quantity information may be uploaded into the system to run regulatory reports that are determined by threshold quantities. For example, a user can upload quantity information such as average daily usage, max daily usage, and annual usage, for purposes of running reports based on regulatory information including, for example, certain lists 280 based on the U.S. Superfund Amendments and Reauthorization Act (“SARA”). In certain embodiments, inbound MSDSs and components of MSDSs are typically cross-referenced against a library of global chemical identifiers that may comprise over 480,000 entries. As a result an MSDS can be searched using expanded criteria although this information may not be listed explicitly on the MSDS. For example, a user may enter a molecular formula or European Inventory of Existing Commercial Chemical Substances (‘EINECS”) number into the search criteria to locate a particular MSDS or product within an inventory. In certain embodiments, the user may search for an MSDS utilizing search criteria based on a global database of over 1 million chemical names that includes synonyms and translations. For example, a user may search for Benzene and receive results for Benzene, Benène, Benzol, etc.

In certain embodiments, the users may conduct a search utilizing one or more generics databases to identify chemical products and MSDSs in their inventory. For example a user may search for a plurality of different chromium compounds within their inventory by selecting the generic name chromium compound. This information may be used to reduce the amount of a particular compound used across the entire enterprise. In certain embodiments, the use of fuzzy search technology for product names, chemical names 260, etc, may be implemented to improve the MSDS search process.

In certain embodiments, information identifying chemical products can be entered into the system and processed to obtain composition information that may be used to identify products impacted by one or more regulations. Results obtained can be used to produce detailed reports 240 at the product and CAS level that provide information regarding the selected regulation. For example, a user can locate all products within their inventory that contain SARA 313 regulated chemicals 280 and may obtain a detailed summary report that provides additional information such as de minimis concentration values for that particular chemical by selecting a from a list of located products.

In many embodiments, systems and processes perform regulatory impact analysis that can enable users to view regulatory changes that specifically apply to products of interest such as products maintained in the users' inventories and/or product catalogs 220. Information obtained by implementing regulatory impact analysis features can then be used to modify safety programs, policies and training and improve workplace safety. Additionally, users can be notified of changes in regulations that may effect reporting requirements. Prompt, appropriate response to regulatory changes can positively impact regulatory compliance and increase workplace safety. Thus, aspects of the invention facilitate and automate management of complex regulatory compliance for large numbers of chemicals while reducing costs.

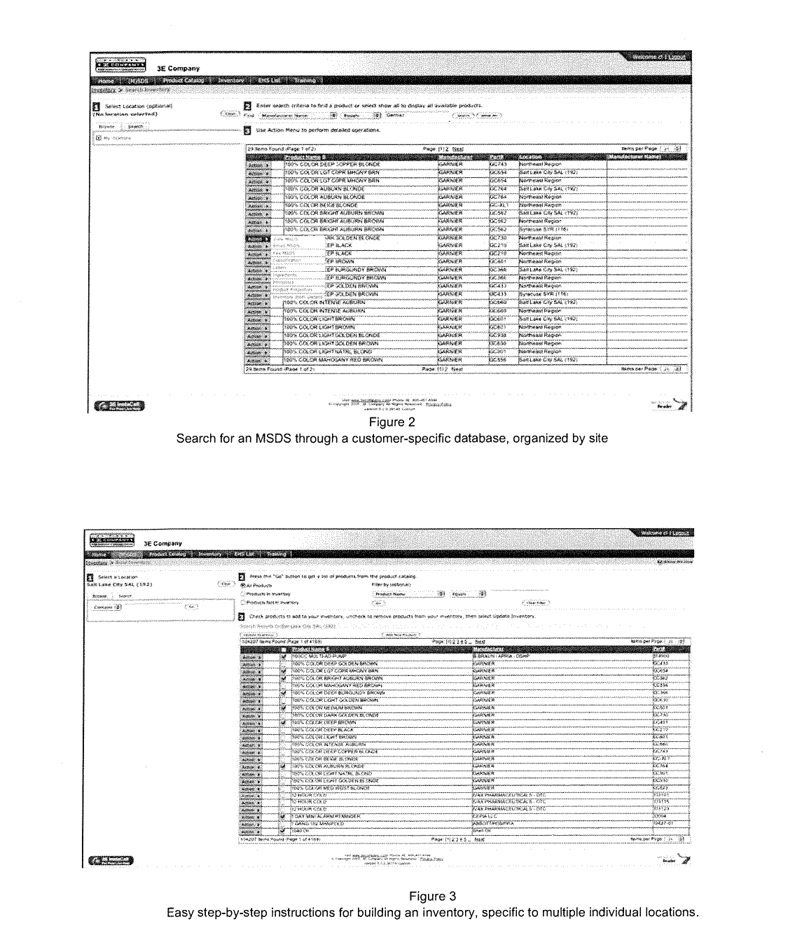

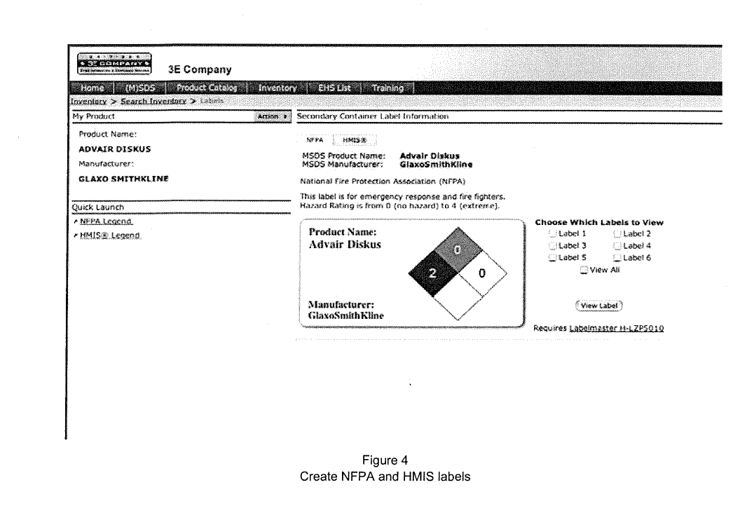

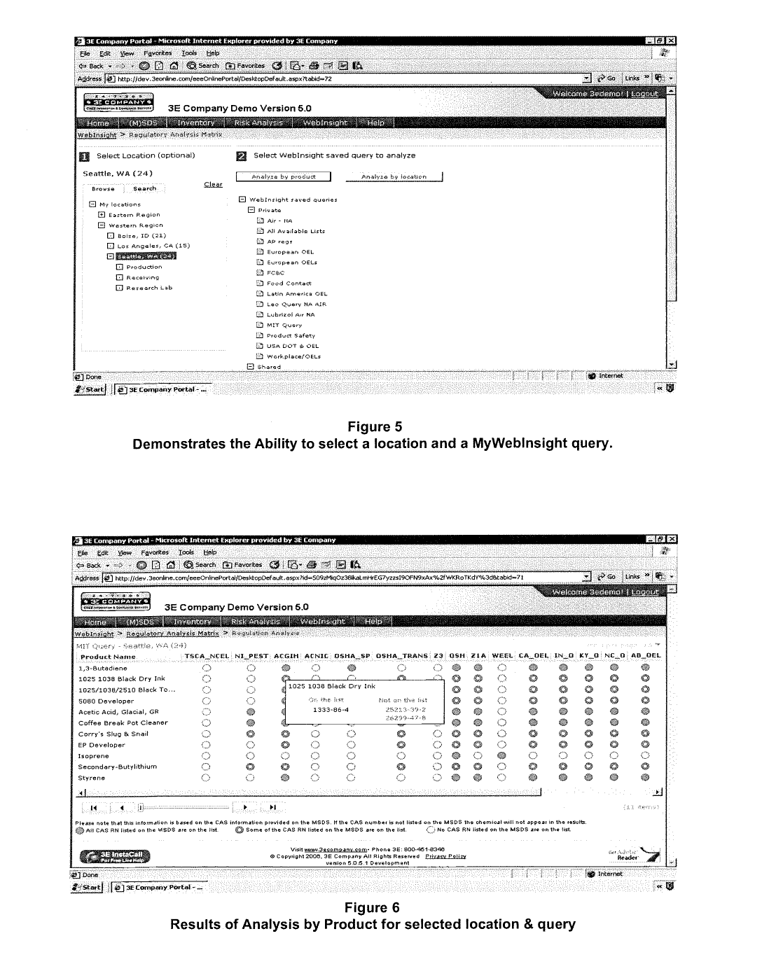

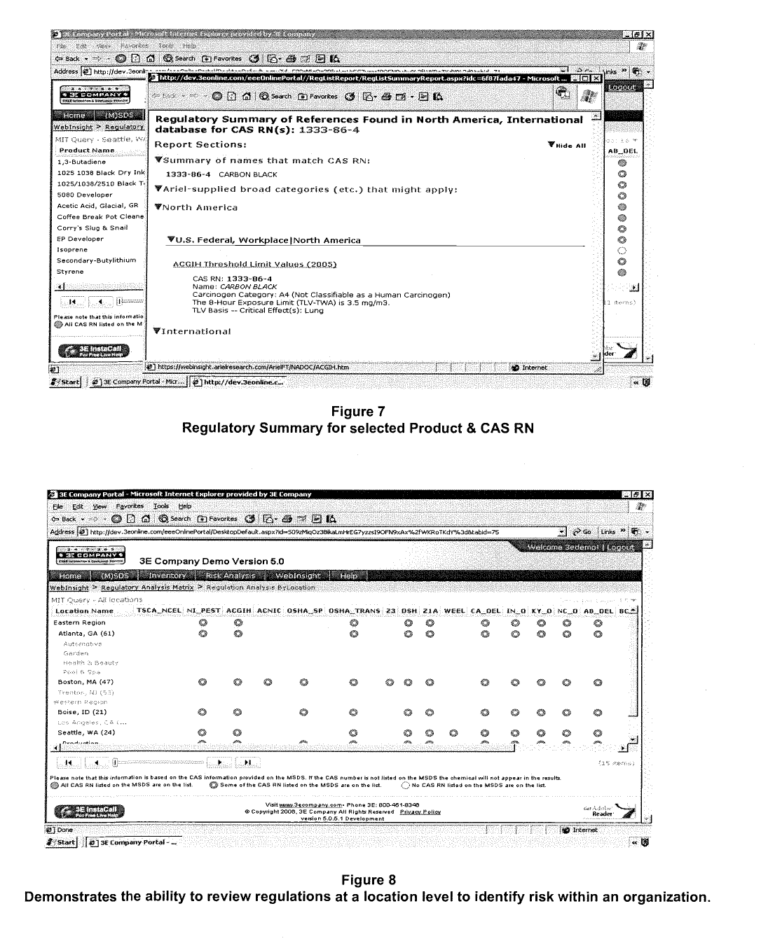

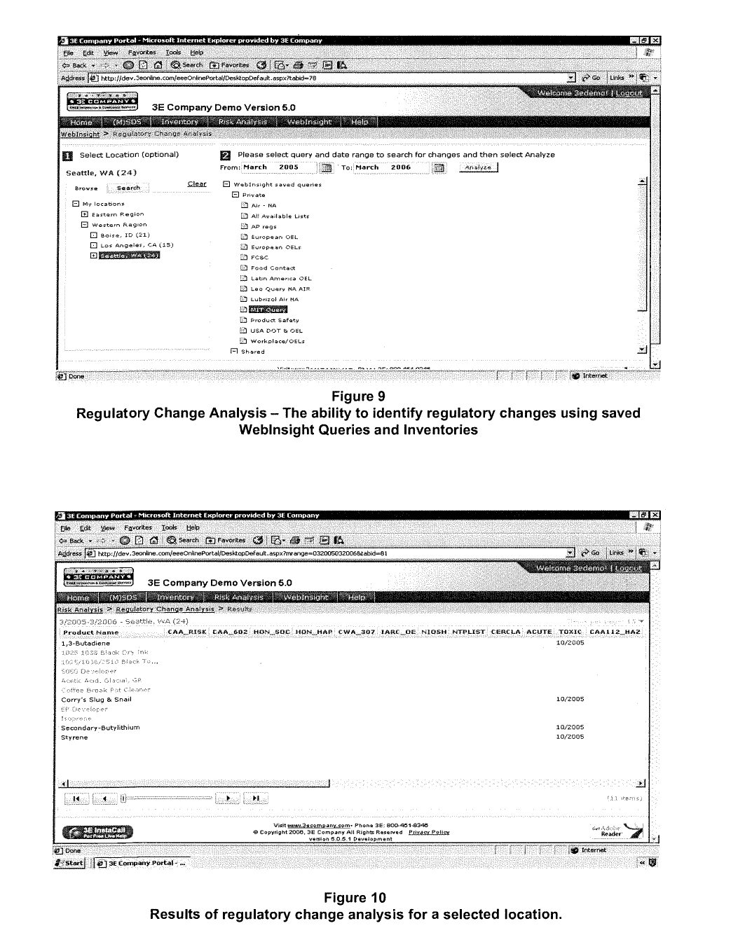

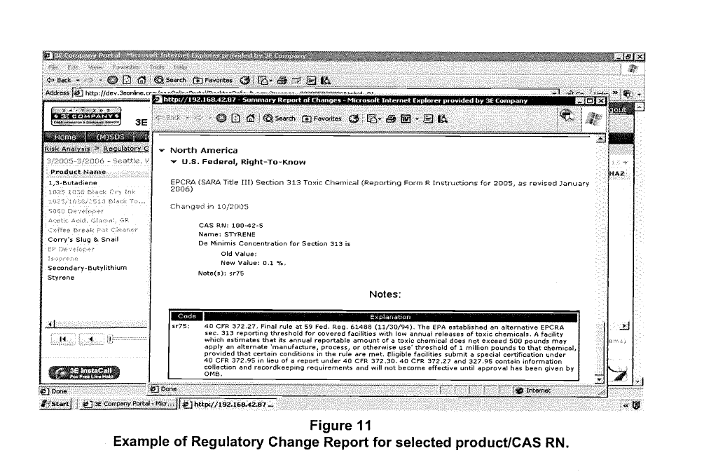

Operation of certain embodiments of the invention can be better understood by referring to the exemplars of operation of one system as shown in FIGS. 2-11. Certain embodiments comprise systems and methods that facilitate access to user defined queries within the MMS and an ability to execute queries at an enterprise level to calculate and/or uncover specific regulatory liabilities. From enterprise level, a user may drill down to a location/inventory level to identify and review products associated with the query. For example, a user can run a workplace safety query at the enterprise level and then select a location to determine which products are included in each of one or more lists generated in response to the query. In certain embodiments, a regulatory analysis matrix can provide snapshots that may be organized or arranged by enterprise, product and/or location. Graphical indicators may be provided to permit users to see which products are listed and reasons for listing.

In certain embodiments, global regulatory summary reports can be generated and presented on request or in response to an event or schedule. Custom queries can be created within the MMS that cause reports to be created, whereby the reports can be indexed, arranged or otherwise organized based on a combination of specific CAS RNs, global regulatory lists and/or selected ingredients. Results of the query can include reports organized by product for a specific list and by CAS for specific list. These reports can be dynamically created such that lists may be automatically updated as regulatory content changes or is updated. In one example, a user may build a list to track California Prop. 65 chemicals present in inventory. As products and/or constituents are added to the California Prop 65 list, the report can be dynamically expanded to include the new chemicals, typically when the new chemicals are present in inventory.

In certain embodiments, a global rules-based engine is provided to further evaluate compliance factors and to identify regulatory applicability with regards to requirements set by regulatory authorities, agencies and governments such as the U.S. Occupational Health and Safety Administration (“OSHA”), U.S. Department of Transportation (“DOT”) and the European Union (“EU”). For example, one set of rules may be configured to validate whether one or more MSDSs are required for a particular material and for a selected jurisdiction. In another example, the rule-based engine may be configured to provide an evaluation of certain MSDS components to determine the existence and nature of chemical classifications, DOT classification or other global requirements.

In certain embodiments, systems and methods provide access to user defined queries within the MMS and an ability to run the queries against user-specific MMS product inventories. In certain embodiments, systems and methods provide an ability to run queries by location and/or product. In certain embodiments, queries can be run at the enterprise level to show all locations with specific regulatory liabilities. Furthermore, additional information can be obtained by “drilling” into a location to see what products are regulated there, for example.

In certain embodiments, a “regulations-at-a-glance” feature may be implemented to provide snapshots of regulatory and other information for each product and/or location, along with graphical indicators that permit users to determine which products are on the list and why those products are on the list. Regulatory summary reports can be generated and can include reports organized by product for a specific list and/or by CAS for a specific list. In certain embodiments, custom lists can be created and maintained to include a combination of specific CAS numbers and regulatory lists. Custom lists may be regarded as “live” or dynamic lists in contrast to certain lists which are typically static, including lists based on CAS RN enumeration; dynamic or live lists typically change automatically when corresponding regulatory lists are updated.

In certain embodiments, the MMS comprises a central MSDS service (“MMS-MSDS”) that can provide continuous online access to information related to a hazardous material inventory maintained by a user and associated MSDSs. Typically, access is provided continuously on a 24 hour basis for every day of the year facilitating immediate viewing and printing of any MSDS for chemicals related to the user inventory. Access can be provided by Internet, WiFi, and any other suitable communications system. Access to MSDS information 100 can be provided in compliance with regulatory requirements such as the U.S. OSHA Hazard Communication Standard, 29 CFR 1910.1200.

In certain embodiments, the MMS-MSDS comprises site-specific MSDS management tools and services to track the location of the user inventory. Management tools can include MSDS Search, Inventory Management and Regulated Chemical Lists. MMS-MSDS can be further customized to provide services and features such as classification, SARA candidate lists, labeling features, chemical approval services and authoring or generation of customer proprietary documents. It will be appreciated that the provision of services using the Internet can also be delivered using intuitive Web browser interfaces to facilitate easy access to EH&S information and compliance information. Web-based solutions can be easily customized and configured without a requirement for installation or reconfiguration of user computer equipment. However, in some instances, certain plug-ins may be installed or activated ion the user computer equipment to properly render transmitted information and some configuration and identifying information may be stored on the user computer equipment. Plug-ins that may be installed can include Java, Active-X, QuickTime, Flash and custom plug-ins.

In certain embodiments, services provided by the MMS include chemical classification. Products can be classified using any desired system of classification, including, in the example of the United States, the National Fire Protection Association (“NFPA”) system and Hazardous Materials Identification System (“HMIS”) ratings. Chemical classification typically includes evaluating products according to federal, state and local standards. In the latter example, products can be classified according to standards promulgated by organizations such as the NFPA and the International Code Council (ICC); classification can include capturing key physical property information from corresponding and related MSDSs and capturing information necessary to satisfy SARA classification elements.

In certain embodiments, services provided by the MMS include SARA candidate list generation. Candidate lists can be generated by product or by chemical and certain lists may detail a chemical inventory against SARA Title III Sections 311/312/313 criteria including fire, reactivity, pressure, acute and chronic health hazard. In certain embodiments, services provided by the MMS include labeling services including generating of various labels. Labeling services can facilitate viewing and printing of NFPA and HMIS secondary container labels using custom labels with specific product or usage notes.

In certain embodiments, services provided by the MMS include chemical approval services. Chemical approval services include flagging products for addition or deletion in a chemical inventory for internal review and approval. For example, an MMS-MSDS may be configured to automatically place an added or deleted product in a holding area, thereby triggering a notification of the proposed change to an inventory. A customer may then review an MSDS provided by the system before causing the change to be reflected in the inventory. Upon approval, the customer can delete or move the product and MSDS image to the desired facility location.

In certain embodiments, services provided by the MMS include customer proprietary document management services. Internal hazardous material documents from a customer-specific 3E MSDS database can be stored, viewed and printed. In one example, the MMS-MSDS can also serve as or maintain a central repository for hazardous communications plans, records, procedures, storage guidelines or any other text necessary in connection to maintaining a safe working environment and the management of hazardous materials. Designated internal administrators can add, delete or group documents using an automated tool before the documents are made globally available for review. Documents may be provided in a variety of formats, including PDF and image formats.

In certain embodiments, services provided by the MMS include inventory management services. The provision of a clear and accurate chemical inventory addresses an important aspect of both the MMS-MSDS service and a hazardous materials information management system operated by the user. This chemical inventory can also facilitate the provision of improved HazMat compliance through identification of associated regulations. The chemical inventory can support training, handling, storage, use and disposal requirements associated with chemicals identified in the inventory. In this regard, information derived from the MSDSs, the chemical inventory and a regulatory database can be used to generate or identify procedures for handling, using, selling, storing, transporting, and disposing of chemical products, including clean-up and spill handling procedures. These procedures may be disseminated by subscribers and/or manufactures and may include mandates of regulatory authorities.

In certain embodiments, services provided by the MMS include inventory maintenance services. Customers can update, add, or delete products as well as generate reports. Hazardous materials inventories are typically made available real-time in both summary and detail format. Product-specific notes can be added at any time and may be made visible to all employees of a subscribing company or organization. In certain embodiments, customers can add custom value fields to specify, for example, desired search criteria on a set number of custom value fields based on internal processes and policies. In certain embodiments, services provided by the MMS include onsite inventory assessment. The MMS can facilitate a review of inventory using existing lists of products and can receive information obtained during an onsite audit and one or more lists can be updated or generated as a site-specific inventory.

In certain embodiments, services provided by the MMS include organization, cross-referencing and sorting of an inventory. In one example, the MMS-MSDS system can facilitate review of lists obtained from an inventory. Review may be performed automatically or by specialists in hazardous materials management and handling. Typically, the review identifies which products may require generation or maintenance of an MSDS. Lists can be cross-referenced against a plurality of commercially available databases or from individual manufacturers or vendors. An example of a commercially available database is provided by 3E Company of Carlsbad, Calif. which provides a massive cross-industry MSDS database.

In certain embodiments, the MMS enables provision of MSDS obtainment service. In one example, HazMat specialists can maintain the MMS database through a regular review of all MSDSs to ensure that the most current MSDS is available to customers for each chemical and chemical product in inventory. MSDSs may be received in the database directly from a manufacturer when an update is issued or new product released. When a new MSDS is obtained, it is typically scanned to produce a PDF image. In addition to the image, key fields can be captured as indexes and search terms to enable easy searches by product names, product numbers, chemical ingredients, physical properties and other important data. Additionally, meta data can be added to the database and associated with new and updated entries as appropriate. In certain embodiments, interpreted, keyed and otherwise enhanced copies of data can be stored together with original data received from the manufacturer.

In certain embodiments, the MMS includes services that control access to historical records. For example, expired MSDSs can be archived at a secure storage facility in various forms, including in printed and electronic format, such as DAT tape, CD-ROM, DVD-ROM and so on. Users can be provided access to these archived MSDSs upon request.

In certain embodiments, the MMS provides one or more comparison services whereby a site-specific inventory can be compared to regulatory lists in order to identify regulated or potentially regulated products and chemicals. In the example of the United States, regulatory lists can include lists associated with SARA, the Comprehensive Environmental Response, Compensation, and Liability Act (“CERCLA”) and the Toxic Substances Control Act (“TSCA”). In one embodiment, Ariel™ Data, an RCD provided by 3E Company of Carlsbad, Calif., can generate and maintain more than 650 regulatory lists. It will be appreciated that certain embodiments of the invention can support and maintain global identifier databases, regulatory databases, and chemical synonym databases.

In certain embodiments, MSDS information 100 can be obtained by accessing the MMS using networks, including the Internet, one or more intranets, WiFi, cellular communications, satellite communications and other technologies. In certain embodiments, service providers such as 3E Company of Carlsbad, Calif. can maintain hosted secure websites for a plurality of subscribers and can provide customer-specific database access via an intuitive, easy-to-use web browser interface. Typically, web based solutions offer the advantage that no client-side installation is required.

In certain embodiments, tools for building an inventory can be provided for subscriber and/or service provider use. An inventory building tool can include tutorials and step-by-step instructions for building inventories of MSDSs that can be organized according to location. In certain embodiments, MSDS search tools can be provided for searching, viewing, printing and emailing MSDSs. Searches can be conducted by product name, manufacturer, internal number, CAS# or chemical name. In certain embodiments, access to backup data is provided. In one example, the MSDS On Demand® Backup tool provided by 3E Company of Carlsbad, Calif. enables round-the clock access to backed-up data by Fax, Internet, intranet, WiFi and telephone including cellular networked devices.

Certain embodiments comprise a security system that controls access to the MMS according to user authorization levels. Users can typically be segmented and granted access to certain functional or administrative features.

### ADDITIONAL DESCRIPTIONS OF CERTAIN ASPECTS OF THE INVENTION

Certain embodiments of the invention comprise methods and systems for determining regulatory compliance of the chemical product inventory and, in certain embodiments, for assessing regulatory risks corresponding to the chemical inventory. In certain embodiments combinations of functions, actions and features are supported, including adding a product to a catalog, obtaining inbound MSDSs for selected products on a global basis.

In certain embodiments, functions, actions and features can also include evaluation and validation of inbound MSDS from chemical and regulatory standpoints, extraction of MSDS meta-data into a database. Data in an MSDS may be incomplete and a vendor MSDS management process can be employed that provides a “validation/refinement” phase to overwrite composition information and add at least some hazardous information about proprietary materials. Validation may also include data refinement based on a generics component of a regulatory database.

In certain embodiments, functions, actions and features can also include performing additional value-added regulatory classifications as needed and appending the results to meta-data, adding a product to the inventories at various locations and cross-referencing inbound MSDSs with a database of global chemical identification information. This processing can allow information to be searched using various criteria; thus, MSDSs and related information can be found even if the documents do not contain search patterns explicitly. In certain embodiments, cross-referencing may be leverage integration with a regulatory database system and may facilitate the discovery and locating of documents that do not have explicit search patterns in them. This discovery and location process can be implemented as a specialized chemical identifier thesaurus. In one example, the regulatory database maintains a library of over 480,000 identifiers.

In certain embodiments, a regulatory database is provided that maintains a global database of chemical names including synonyms and translations. Such global database may well have entries counted in the millions. In certain embodiments, functions, actions and features can also include an MSDS search functionality that uses a database of chemical synonyms in many languages (such as Benzene, Benène. Benzol, etc.), an MSDS search functionality using generics, an MSDS search functionality using fuzzy searches for processing terms including product names and chemical names.

In certain embodiments, functions, actions and features can also include cross-referencing inventories with a database of global chemical regulatory information, uploading quantities for chemical product inventories for tracking and generating volume-driven assessments, generating regulatory reports at various enterprise levels (corporation, plant, etc.) and generating regulatory impact analysis reports. For example, reporting, tracking and generating volume-driven assessments may be required by EU Registration, Evaluation and Authorisation of Chemicals (“REACH”) and SARA, etc.

In certain embodiments, functions, actions and features can also include using generated reports to assess regulatory compliance and risks to further evaluate compliance risks. Evaluation of compliance risks can include the use of rule-based methods, including expert systems. In one example, a first set of rules may be used to evaluate whether a vendor MSDS is required for a material in a particular jurisdiction, while other sets of rules may provide additional classifications that facilitate the evaluation of other global compliance risks. In certain embodiments, functions, actions and features can also include Web-based system and outsourcing models.

Certain embodiments of the invention include a method of accessing regulatory information associated with a chemical product, comprising deriving a list of constituents of the chemical product, wherein deriving includes analyzing material safety data sheet data corresponding to the chemical product, querying a database of regulatory data based on the constituents, and reporting regulations associated with the chemical product. In certain embodiments, the constituents include chemicals present in the chemical products. In certain embodiments, the constituents include derivatives of the chemicals present in the chemical product. In certain embodiments, the material safety data sheet data is maintained in a database. In certain embodiments, the material safety data sheet data includes raw material safety data sheets. In certain embodiments, the raw material safety data sheets are provided by one or more manufacturers of the chemical product. In certain embodiments, the raw material safety data sheets include material safety data sheets associated with generic versions of the chemical product. In certain embodiments, the material safety data sheet data includes procedures for handling the chemical product. In certain embodiments, the material safety data sheet data includes procedures for transporting the chemical product. In certain embodiments, the material safety data sheet data includes procedures for storing the chemical product. In certain embodiments, the material safety data sheet data includes procedures for disposing of the chemical product. In certain embodiments, deriving a list includes obtaining chemical names associated with the chemical product. In certain embodiments, the chemical names include generic names. In certain embodiments, the chemical names include names of constituents of the chemical product. In certain embodiments, the chemical names include names of derivatives of the chemical product. In certain embodiments, the chemical names are obtained from one or more regulatory lists. In certain embodiments, the one or more regulatory lists include SARA lists. In certain embodiments, the database of regulatory data includes regulatory information received from a plurality of regulatory authorities. In certain embodiments, the regulatory authorities include two or more different governments. In certain embodiments, the querying includes providing the list of constituents. In certain embodiments, the querying is further based on derivatives of the chemical products and wherein the querying includes providing a list of the derivatives. In certain embodiments, the querying includes identifying one or more material safety data sheets related to the chemical product.

Certain embodiments provide a method of reporting chemicals impacted by regulatory requirements, comprising providing information identifying one or more chemical products, wherein the information includes chemical names of constituents of the one or more chemical products, searching a compilation of regulatory data based on the chemical names to obtain regulations related to the chemical products, and generating a report describing the impact of the regulations on operations involving the one or more chemical products. In certain embodiments, the chemical names include a generic name of the one or more chemical products. In certain embodiments, the generic name is obtained by searching a generics database. In certain embodiments, the chemical names include generic names of at least one of the constituents. In certain embodiments, the generic name is obtained by searching a generics database. In certain embodiments, the operations include transportation of the one or more chemical products. In certain embodiments, the operations include storage of the one or more chemical products. In certain embodiments, the operations include disposal of the one or more chemical products. In certain embodiments, the operations include manufacturing operations. In certain embodiments, the generating the report includes identifying regulated chemicals in an inventory of chemicals. In certain embodiments, the generating the report includes providing quantity information for each of the regulated chemicals. In certain embodiments, the generating the report includes providing notification of changes in the regulations. In certain embodiments, the providing the notification includes generating an analysis of impact of the changes.

In certain embodiments a system for accessing regulatory information associated with a chemical product, comprises a database of material safety data, the material safety data including a plurality of material safety data sheets (“MSDSs”) and information related to the MSDSs, a database of regulatory data compiled from information obtained from a plurality of regulatory authorities, one or more application servers configured to receive a query identifying one or more chemical products and retrieve chemical names related to the one or more chemical products based on the material safety data, and a search component configured to identify regulations in the regulatory data responsive to the query. In certain embodiments, the chemical names include generic names. In certain embodiments, the search component is an application server. In certain embodiments, the search component is executed by the one or more application servers. In certain embodiments, the identified regulations govern operations related to the one or more chemical products. In certain embodiments, the operations include transportation of the one or more chemical products. In certain embodiments, the operations include storage of the one or more chemical products. In certain embodiments, the operations include disposal of the one or more chemical products. In certain embodiments, the operations include manufacturing operations.

It is apparent that the above embodiments may be altered in many ways without departing from the scope of the invention. Further, various aspects of a particular embodiment may contain patentably subject matter without regard to other aspects of the same embodiment. Additionally, various aspects of different embodiments can be combined together. Also, those skilled in the art will understand that variations can be made in the number and arrangement of components illustrated in the above diagrams. It is intended that the appended claims include such changes and modifications.

What is claimed is:

1. A method of accessing regulatory information associated with a chemical product, comprising:
deriving a list of constituents of the chemical product, wherein deriving includes analyzing material safety data sheet data corresponding to the chemical product;
querying a database of regulatory data based on the constituents; and
identifying regulations associated with the chemical product.

2. The method of claim 1, wherein the constituents include chemicals present in the chemical products.

3. The method of claim 2, wherein the constituents include derivatives of the chemicals present in the chemical product.

4. The method of claim 1, wherein the material safety data sheet data is maintained in a database.

5. The method of claim 4, wherein the material safety data sheet data includes raw material safety data sheets.

6. The method of claim 5, wherein the raw material safety data sheets are provided by one or more manufacturers of the chemical product.

7. The method of claim 5, wherein the raw material safety data sheets include material safety data sheets associated with generic versions of the chemical product.

8. The method of claim 4, wherein the material safety data sheet data includes procedures for handling the chemical product.

9. The method of claim 4, wherein the material safety data sheet data includes procedures for transporting the chemical product.

10. The method of claim 4, wherein the material safety data sheet data includes procedures for storing the chemical product.

11. The method of claim 4, wherein the material safety data sheet data includes procedures for disposing of the chemical product.

12. The method of claim 1, wherein the deriving a list includes obtaining chemical names associated with the chemical product.

13. The method of claim 12, wherein the chemical names include generic names.

14. The method of claim 12, wherein the chemical names include names of constituents of the chemical product.

15. The method of claim 12, wherein the chemical names include names of derivatives of the chemical product.

16. The method of claim 12, wherein the chemical names are obtained from one or more regulatory lists.

17. The method of claim 16, wherein the one or more regulatory lists includes SARA lists.

18. The method of claim 1, wherein the database of regulatory data includes regulatory information received from a plurality of regulatory authorities.

19. The method of claim 18, wherein the regulatory authorities include two or more different governments.

20. The method of claim 1, wherein the querying includes providing the list of constituents.

21. The method of claim 12, wherein the querying includes providing the list of constituents.

22. The method of claim 1, wherein the querying is further based on derivatives of the chemical products and wherein the querying includes providing a list of the derivatives.

23. The method of claim 1, wherein the querying includes identifying one or more material safety data sheets related to the chemical product.

24. A method of reporting chemicals impacted by regulatory requirements, comprising:
providing information identifying one or more chemical products, wherein the information includes chemical names of constituents of the one or more chemical products;
searching a compilation of regulatory data based on the chemical names to obtain regulations related to the chemical products; and
generating a report describing the impact of the regulations on operations involving the one or more chemical products.

25. The method of claim 24, wherein the chemical names include a generic name of the one or more chemical products.

26. The method of claim 25, wherein the generic name is obtained by searching a generics database.

27. The method of claim 24, wherein the chemical names include generic names of at least one of the constituents.

28. The method of claim 27, wherein the generic name is obtained by searching a generics database.

29. The method of claim 24, wherein the operations include transportation of the one or more chemical products.

30. The method of claim 24, wherein the operations include storage of the one or more chemical products.

31. The method of claim 24, wherein the operations include disposal of the one or more chemical products.

32. The method of claim 24, wherein the operations include manufacturing operations.

33. The method of claim 24 wherein the generating the report includes identifying regulated chemicals in an inventory of chemicals.

34. The method of claim 33, wherein the generating the report includes providing quantity information for each of the regulated chemicals.

35. The method of claim 33, wherein the generating the report includes providing notification of changes in the regulations.

36. The method of claim 35, wherein the providing the notification includes generating an analysis of impact of the changes.

37. A system for accessing regulatory information associated with a chemical product, comprising:
a database of material safety data, the material safety data including a plurality of material safety data sheets (“MSDSs”) and information related to the MSDSs;
a database of regulatory data compiled from information obtained from a plurality of regulatory authorities;
one or more application servers configured to receive a query identifying one or more chemical products and retrieve chemical names related to the one or more chemical products based on the material safety data; and
a search component configured to identify regulations in the regulatory data responsive to the query.

38. The system of claim 37, wherein the chemical names include generic names.

39. The system of claim 37, wherein the search component is an application server.

40. The system of claim 37, wherein the search component is executed by the one or more application servers.

41. The system of claim 37, wherein the identified regulations govern operations related to the one or more chemical products.

42. The system of claim 41, wherein the operations include transportation of the one or more chemical products.

43. The system of claim 41, wherein the operations include storage of the one or more chemical products.

44. The system of claim 41, wherein the operations include disposal of the one or more chemical products.

45. The system of claim 41, wherein the operations include manufacturing operations.
